(19) United States
(12) Patent Application Publication
(10) Pub. No.: US 2005/0257242 A1
(43) Pub. Date: Nov. 17, 2005

(54) Multicast video edit control

(75) Inventors: Stephen J. Montgomery, Highlands Ranch, CO (US); John C. Beyler, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Starz Entertainment Group LLC, Englewood, CO (US)

(21) Appl. No.: 11/173,242

(22) Filed: Jul. 1, 2005

Related U.S. Application Data
(63) Continuation-in-part of application No. 10/802,043, filed on Mar. 15, 2004.
(60) Provisional application No. 60/585,483, filed on Jul. 2, 2004.
(60) Provisional application No. 60/455,009, filed on Mar. 14, 2003.

(51) Int. Cl. H04N 7/173

(52) U.S. Cl. 725/116

(57) ABSTRACT

According to the invention, a content receiver for processing a video program into an edited video program as specified by a user is disclosed. The content receiver includes a version profile, user preferences and a receiver. The version profile indicates a plurality of electronic edits for applying to the video program. The user preferences specify the version profile, where the user preferences are associated with the user. The receiver receives at least one of the version profile and the video program. The video program is received in digital form from a first location geographically separate from the second location. The video program is processed at the second location with the version profile to produce an edited video program. The edited video program is played for the user.

This application claims the benefit of and is a non-provisional of U.S. Provisional Application Ser. No. 60/585,483 filed on Jul. 2, 2004; and also claims the benefit of and is a continuation-in-part of U.S. application Ser. No. 10/802,043 filed on Mar. 15, 2004, which is a non-provisional of U.S. Provisional Application Ser. No. 60/455,009 filed on Mar. 14, 2003; which are all incorporated by reference in their entirety for all purposes.

### BACKGROUND OF THE DISCLOSURE

This disclosure relates in general to content distribution and, more specifically, but not by way of limitation, to multicast media editing.

Linear programs are delivered to multiple viewers in a single format. A user can tune to a particular program and view it without modification. Some set top boxes have personal video recorder (PVR) capability that allows pausing and rewinding through a buffer that holds the linear program stream. There is no ability to edit the format of a linear program.

Content distributors have made different versions of programs for different channels. One version could be destined for paid cable, while another is for broadcast television. Those two different versions are prepared and distributed separately. A user can choose one or the other version in its distributed form.

There have been crude attempts to automatically edit programs. One device used closed caption text to detect certain keywords. When a keyword was detected, the audio track would be “beeped” out with a tone to mask the offensive keyword. Often, the closed captioning text does not closely match the sound track such that censoring is crude.

A PVR includes a hard drive to store programs. Those programs are recorded from a linear schedule of programs. The stored programs can be played back with temporal control that allows various trick modes of playback, for example, fast-forward/reverse, slow playback, pause, etc. Programs stored on the PVR are not edited.

### BRIEF DESCRIPTION OF THE DRAWINGS

The present disclosure is described in conjunction with the appended figures:

FIGS. 1A and 1B are block diagrams, depicting embodiments of a program delivery system using satellite transmission or the Internet to each set top box;

FIG. 2 is a block diagram illustrating an embodiment of a set top box that stores alternate version profiles, program information, programs and preferences locally;

FIG. 3 is a screen shot of an embodiment of a program editing application;

FIG. 4 is a flow diagram of an embodiment of a process for customizing received programs; and

FIGS. 5A and 5B are flow diagrams of embodiments of a process for manipulating and displaying a program.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment or computer-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

A video program is conventionally produced with an original cut. One or more parties involved in production of the video program (e.g., the director) produce the original cut. Special-purpose cuts may be defined in the same manner (e.g., various aspect ratios, different MPAA ratings, commercial airline version, foreign language dubbed version, content advisories, broadcast television appropriate version, etc.) and are conventionally distributed as separate versions of the video program. The original cut typically cannot be produced from these special-purpose cuts as they are a subset of the scenes.

One embodiment of the invention has a version profile corresponding to the various special-purpose cuts. A user can, for example, specify that one or all video programs be edited automatically to conform with a MPAA G content rating. The original cut would be edited after multicast or broadcast distribution to conform with a MPAA G rating according to the corresponding version profile. These can be specified when the original cut is produced or later by a content provider involved in distribution.

In one embodiment, the original video portions produced when the video program is produced could be distributed. The original cut could be specified as one of the version profiles. In this way, a special-purpose cut could include more or different scenes than the original cut. For example, a program distributed as the original video portions could have a director's-cut version profile that would produce a special-purpose cut with a longer run time, alternative ending, etc. The content used to replace or add to the original cut could be included at the time the program is sent or could be downloaded later.

Video and audio content control can also be performed by version profiles to produce a custom cut from the original cut. Specific sounds or images can be removed to produce a custom cut. The user can specify particular language or sounds, for example, that should be replaced, obscured with another sound, or removed entirely. In one example, the user could specify that all vulgar language be replaced with pre-recorded alternatives. The particular words to replace could be specified in some embodiments such that any occurrence were modified. In a similar way, video content control could remove, crop-out, replace or blur the offensive images. For example, nude scenes could have the images or parts of the image blurred to obscure the offensive portions. In another example, the scene is shot from two different perspectives or could have different content that can be used interchangeably as specified in the version profile.

A version profile specifies any number of edits to convert the original cut into a special-purpose or custom cut. These edits include such things as removing part of the soundtrack, obscuring part of the soundtrack with a stock sound, replacing part of the soundtrack with a substitute, cropping part of a video image frame, blocking part of the video image frame, blurring part of the video image frame, removing part of the video program, obscuring part of the video program, and/or replacing part of the video program.

In one embodiment, all the common elements among all versions are sent before any customization. These common elements could be distributed in the linear schedule or as a video file(s) in an off-line fashion. The selected version profile(s) would then dictate the additional portions for downloading. The particular custom cut would be compiled by inserting additional portions before viewing of the program or as the program is being viewed.

One embodiment creates the custom cut largely from scratch. The version profile specifies clips and a sequencing between them. Those clips are downloaded to compile the custom cut. This compilation can be done in as the program is viewed or before viewing. The compilation could be performed at the headend or at a user location in various embodiments.

A user can specify a number of version profiles to achieve a presentation appropriate for their unique tastes. In one embodiment, the version profiles are applied in succession starting with the ones with the most extensive editing or vice versa. If a prior version profile edits out something that a subsequent version profile was to edit, that edit is moot and not performed. Some embodiments allow review of the edited clips to allow selecting individual clips to include or exclude.

In various embodiments, the version profiles can be one or more separate files, included as metadata in a specified part of the video program, and/or interlineated as tags embedded in the program. When the various version profiles are produced, a manual and/or automated process would process the original cut and insert tags in the original cut to indicate the possible options. For example, a tag could specify the MPAA rating for an upcoming defined segment, the sexually explicit portions of an image could be defined before a particular frame appears, or a portion of the voice track could be defined as having vulgar language. When the user-preferred version profiles are applied, these tags are used to determine which portions to modify. MPEG private data could be used to indicate the tags or transport the version profile information. Other embodiments wouldn't use tags in the program, but would indicate edits with timestamps such that the appropriate time for edit could be found.

Computer animated video programs could re-render the characters for a particular version profile. For example, a less violent or vulgar version of the video program could be produced. In this embodiment, the version profile effectively rewrites the program in a manner consistent with the user's wishes. A computer at the user location or in two-way communication with the user location could produce a video program or streamed program according to the user preferences that specify one or more version profiles. For example, a character could be rendered at the user location, but from the version profile could render the character differently from the original cut to create the custom cut.

The content distribution system could be any one-to-many topology, for example, cable television, terrestrial broadcast, DBS, multicast IP transport, Internet download, etc. Upstream to the user, one party could define and/or distribute the various version profiles. In the user's location or anywhere a singlecast transmission to the user is possible, the original cut would be customized for the user to create an edited video program customized by the user preferences for that user. This processing could be done for stored programs or while programs are streamed. For streaming media, buffering could be used to avoid gaps in the video where portions are edited out. On demand programs could be processed off-line in a DVR or PVR to produce the special-purpose and/or custom cut.

Some embodiments would allow globally ordering customized cuts according to a particular profile. For all programs that had version profiles, the ones selected by the user would be applied. This would allow customizing some or all programs, services, channels, etc. Disabling or changing the profiles could be protected with a password. Some embodiments could have certain profiles that were used for programs viewed in certain times of the day, week, month, and/or year. For example, all programs played before 8 p.m. would be customized for a G MPAA rating, but the original cut could be viewed later in the night.

Application of a version profile typically changes the length of the program. The program guide could be updated to reflect the viewing time for the particular custom cut selected by the user. The program guide could indicate icons that corresponded to the version profiles applied to the program. Those icons could also be displayed when viewing or intermittently when viewing the custom cut. For example, the user could specify a profile asking for the Spanish audio track for a program. An icon would display in the guide and/or during playback to indicate that it will play with a Spanish soundtrack.

Once the user specifies the version profiles to use for video programs, all programs having those version profiles could be modified in the same way. The user may do this on per user, per television, time period, and/or time of day basis. For example, for the family room television all programs played from 6 a.m. to 10 p.m. would be modified to have a MPAA G rating. Other embodiments could allow specifying the version profiles for each program or overriding a default configuration as necessary. The ability to specify the user preferences could be protected by parental control mechanisms.

In one embodiment, a version profile is used to remove the commercials, product endorsements, station identifiers, product placement, and/or other items from a video program. This could be done for a fee in some embodiments. A portion of each video frame could be overwritten with an alternative or blurred according to the version profile. For example, smoking or alcohol use could be obscured. In one embodiment, for example, a beer can could be overwritten with the image of a soda can to make it appear as though soda is being used.

Another embodiment allows insertion of product placement according to a profile for user. Advertisers could dynamically overwrite product containers, billboards, dialog and other information with products placed dynamically. Different users could get different product placements inserted into the program according to the targets for particular advertisers.

One embodiment has a feature called version chaptering where all the changed segments specified in a version profile can be played in succession. In this mode added, deleted and/or modified scenes are shown according to their sequence in the program. A user could specify more than one version profile for playback. An optionally enabled status line can indicate the type of modification(s) performed to a particular scene. For example, a user could specify that the violent version profile be played in the version chaptering mode and all changes performed because of violent content could be played. The version chaptering mode could be performed by the set top at the user location in one embodiment. The user can selectively re-insert or remove content affected by version profile.

The version profiles effectively code the program based upon the cut made to the original video. A user can specify that the program be played back without the modifications, but have the version profile modifications accentuated during playback. Symbols, sounds and/or descriptions could demark the modified scenes. For example, a cut scene could display a scissors icon or the word “cut” or make a sound to mark the beginning and end of the cut. In one embodiment, the accentuation of the version profile modifications could be performed by the set top at the user location. Another embodiment displays categorization icons of the edit, for example, an “AD” icon could be shown when an adult scene is removed. The icon could be toward the bottom or top edge to be unobtrusive in some embodiments.

The additional or substitute content could be distributed in a number of ways. One embodiment sends all the scenes in a single file. Another embodiment, sends the original cut through the content delivery system, but puts alternate or additional content on a DVD, HD-DVD or some other storage media. The user could load the storage media periodically to load version profiles and additional or substitute content. Yet another embodiment makes the version profiles and additional or substitute content available for download through the same data channel that the unedited program was received from or another data channel.

In one embodiment, scenes of any program are categorized by content, subject, keyword, category, etc. The user can set a version profile that blocks stories based upon content, for example. A customized program that included or excluded sub-stories on a particular subject could be done. In one example, news programs could have a version profile that skips sports stories, violent crime and any story about a particular celebrity. When viewing the news program, those excluded stories would be removed from playback or automatically skipped. Another embodiment could specify in the version profile that the news program should only include weather information and automatic editing would proceed accordingly.

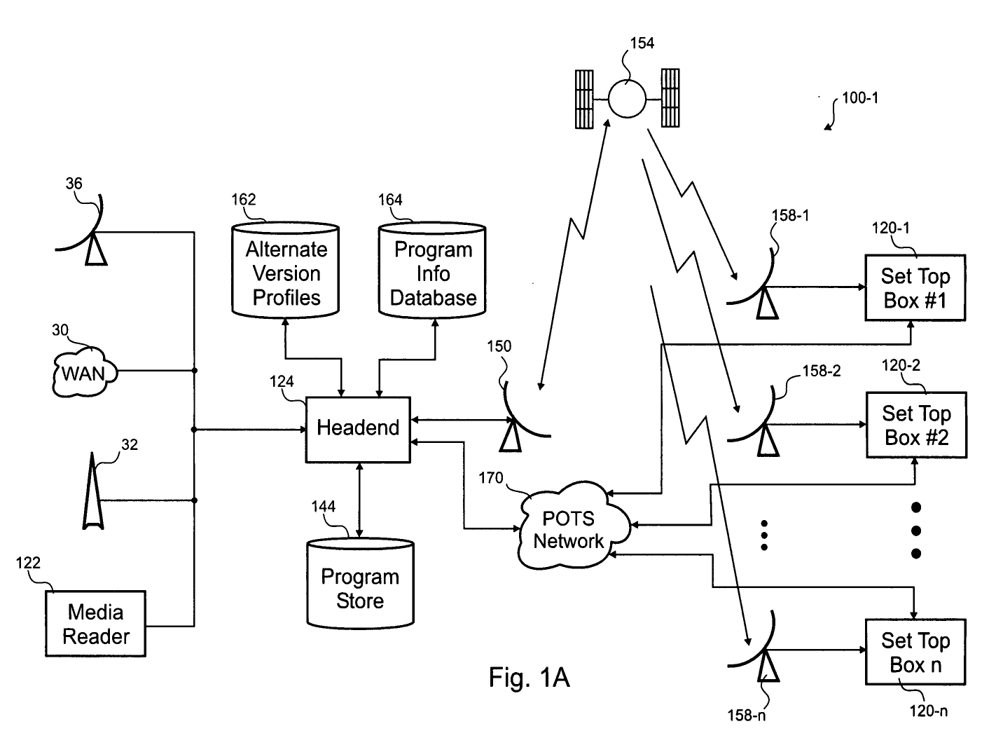

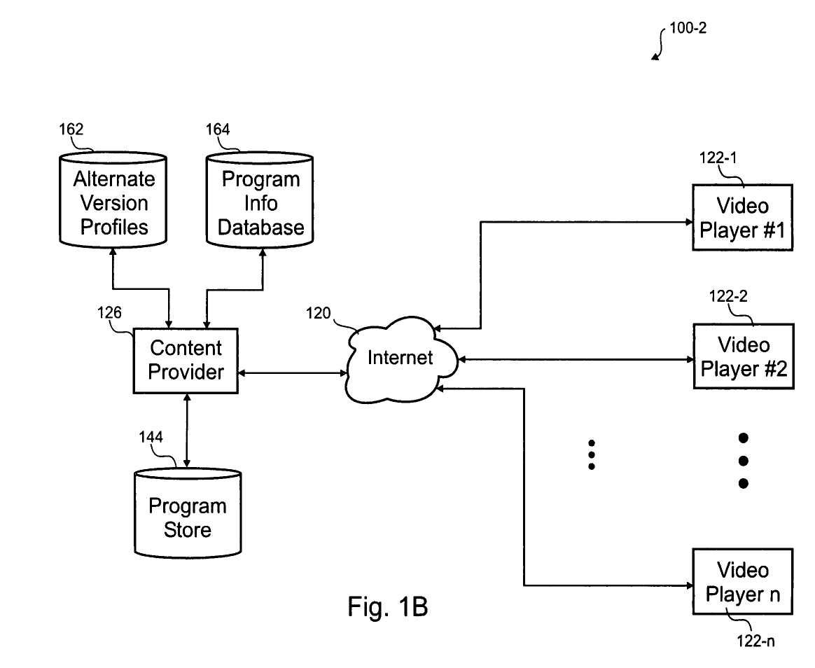

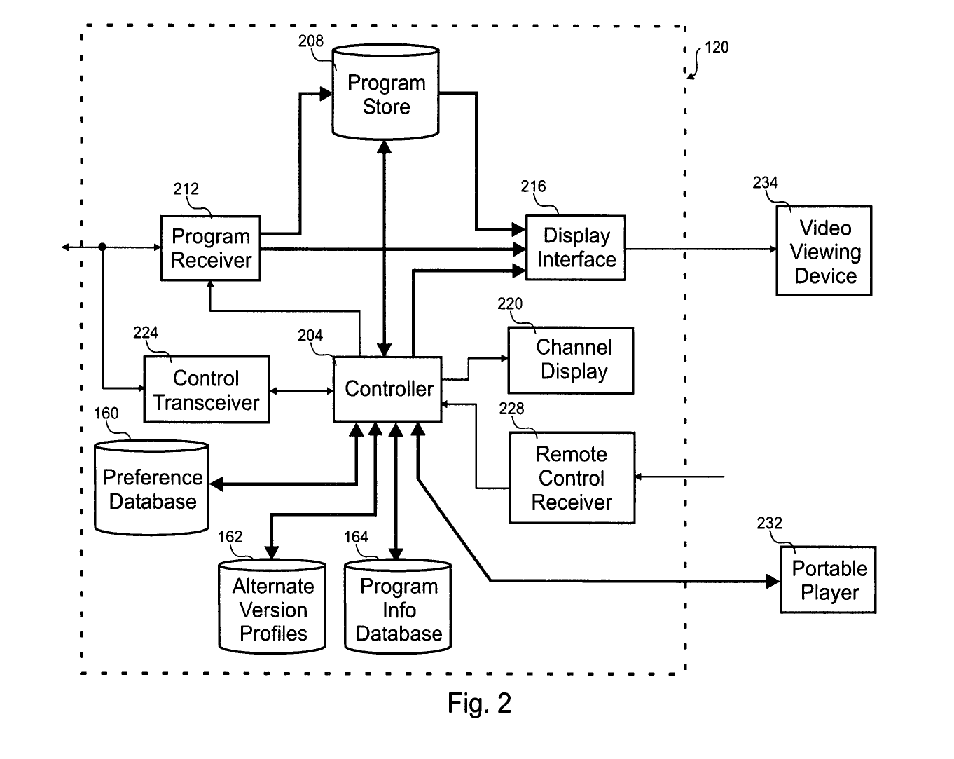

Referring first to FIG. 1A, a block diagram is depicted of an embodiment of a program delivery system 100-1 using satellite transmission to each set top box 120. As used in this application, a set top box 120 is any video or audio playback device that may or may not have an integral display. The content is relayed by satellite 154 to satellite receivers 158 respectively coupled to each set top box 120, but other embodiments could use wireless, HFC, IP transport, WiFi, WiMax, optical fiber, VDSL, DSL, and/or power lines to distribute the content. This embodiment has a return data channel through the plain old telephone system (POTS) network 170, but other embodiments could use a WAN, the Internet, a satellite uplink, a cellular data network, a wireless network, HFC return path, etc. Each set top box 120 in this embodiment includes an interactive program guide (IPG), version profiles, and preference information and store for programs as shown in FIG. 2 that is discussed below. Some legacy set top boxes with limited memory and/or processing capacity could only include guide information without the ability to store programs or preference information, but neighborhood nodes or media gateways could be used to supply added functionality.

A content provider (not shown) communicates, for example, via a satellite dish 36 with the program delivery system 100-2. Other embodiments could have content providers that could also use a wide area network (WAN) 30, a terrestrial antenna 32, a media reader 122, and/or other distribution techniques to send programs and version profiles. The WAN 30 could be a private or public network. Distribution on a public network, such as the Internet, could be protected by encryption and/or virtual private network (VPN) techniques. The terrestrial antennae 32 could accept content broadcast by local stations, sent by microwave link, or other wireless techniques. Any type of portable media could be read by various embodiments of the media reader 122. For example, a media reader 122 could read content from magnetic tape, film, optical disk, flash drives, hard drives, magnetic disks, holographic media, etc.

Some programs are relayed in real-time, while others are stored in a headend program store 144 for later delivery. For example, a local network channel could be received on the terrestrial antennae 32 and coupled to the transmission system for immediate delivery to the set top boxes according to a linear schedule. Some programs could be held in the headend program store 144 for viewing in a linear schedule, on demand and/or as a club program. In another embodiment, programs could be distributed to a neighborhood store for distribution according to a linear schedule, on demand and/or as a club program.

The program store 144 can hold any number of alternative or added clips for a particular program. The added and alternate content could be part of the same file or kept in a number of files.

In one embodiment, a number of neighborhood stores could be distributed to neighborhood nodes in a larger metropolitan area, for example, such that there are sufficient singlecast channels between each neighborhood store and cluster of set top boxes 120. On a singlecast channel, the user can control playback of content residing on the neighborhood store. The programs could be video on demand (VOD), subscription video on demand (SVOD) club programs, network-based personal video recorder (NPVR) or programs from the linear schedule recorded for the user. The neighborhood stores would hold the program and alternate or added content to allow accommodating any combination of version profiles.

The program information database 164 has program descriptions, ratings, advertisements, reviewer rankings, reviews, video vignettes of various sizes, photos or images, genre or theme information, actors, program length, actor and director information, version availability, information on bonus material, schedule times, pricing, alternate version information, and any usage limits for the content available to the program delivery system 100-2. The program information database 164 could be populated by the content provider and/or a third party that gathers this type of information. Some embodiments could download relevant portions of the program information database 164 to each set top box 120 for browsing.

The video vignettes could be available for some or all linear programs, on-demand and stored programs. For a particular program, there could be different length video vignettes (e.g., 5 sec., 15 sec., 30 sec., 1 min., 3 min., or 5 min.), for example, a movie might have a 5 second teaser clip and a 30 second theatrical trailer. A series of programs might have a single video vignette for use with multiple episodes. Some embodiments could create a video vignette from a stored version of the program automatically or could stream a clip from a network connection. Some embodiments could keep video vignettes stored at the user location for the most likely to be viewed programs in general across a number of users or based upon knowledge of viewing preferences for a viewer or account. In some embodiments, the user might be able to specify the encoding quality and length of video vignettes to use. For example, for a low capacity video player, only 5 second clips might be specified with a 150 Kbs codec. Some embodiments may allow video vignettes that are just slide shows of stills from a program. In one embodiment, the video vignettes are not stored at the user location, but streamed there upon demand.

Also, a web site could show this information in addition to making it available through the set top box 120. Programs could be selected for recording and subscriptions (or other club memberships) could be ordered through the web site. One embodiment could formulate the guide screens with information from the program information database 164 for singlecast to a particular user or set top box 120. Program information for on demand offerings are also included in the program information database 164.

In some embodiments, the user is allowed to watch an on demand program during a time window. The program information database 164 could store time window information. Where a particular program is available in the linear schedule and on demand, the program information database 164 could be updated such that this is reflected on the menus for users who have these two formats available. The program information database 164 would have information for the various versions of a particular program. This information can be used to allow customizing the IPG according to any selected version profiles for a particular program.

The program information database 164 further holds various theme categorizations such as genre, style, mood, program length, content rating, language, reviewer ranking, availability of subtitles or closed captioning, actors, directors, studios, release year, first run or repeat, cost of the view, content provider category (pay programming, free program, network offerings, cable offerings, premium channel offerings, etc.), and/or other defining attributes. These categorizations can be used when determining similar material to present to a viewer. Some embodiments allow selecting these theme categorizations and other information in the program information database 164 as part of a search string to filter the various video programs into more manageable searches.

This embodiment also has an alternate version profile database 162, which indicates edits that instruct a set top box or content player how to modify a program. Time stamps are used to indicate where in a program the edit is performed. The edit could be insertion of a clip, deletion of a clip, overwriting the speech or closed caption information, overwriting or blurring a portion of the video frame, cropping part of a video frame, changing aspect ratio, switching to an alternate soundtrack or closed captioning, animating a character differently, etc. For example, a version profile may be selected to always play the directors cut, the Spanish soundtrack or the French subtitles. For each edit, the location for finding the alternative video clip, sound or picture is indicated. Those alternative or substitute content are stored on the program store 144.

Where there are conflicting edits in various version profiles, they may be prioritized such that a combination of various edits would happen in a predetermined manner. The priority would arbitrate between the conflicting instructions. For example, a profile to make a program G rated under the MPAA rating system would have priority over a directors cut profile that would leave in offensive content that would go beyond the G rating. In this example, the MPAA G rating would have a higher priority than any directors cut.

With reference to FIG. 1B, a block diagram is depicted of another embodiment of a program delivery system 100-2 using network transport to each video player 122. The video player 122 could include, without limitation, a television, a computer, a wireless telephone, a personal media player, a set top box, a personal video recorder (PVR), a video cassette recorder (VCR), a personal digital assistant, a cellular phone, a portable game players, an in-car video system, and/or other devices that record and/or display video. The network transport could be over the Internet 120, wireless or any other data transport medium. In this embodiment, a content provider 126 with a program store 144, a alternate version profile database 162 and a program information database 164 sends programs to video players 122. The video players 122 have the ability to display an IPG that is streamed or hosted by the video player 122. The video player may rely upon the content provider 126 for the information in the three databases 144, 162, 164 or might download and store a subset of this information.

Referring next to FIG. 2, a block diagram illustrating an embodiment of a set top box 120 that stores guide information, version profiles, programs, and preferences locally is shown. This embodiment receives content and control information over a common conduit, such as an optical fiber, wireless antenna, network connection, satellite dish, power line carrier current modem, VDSL line, and/or coaxial cable. The set top box 120 in this embodiment, which could be a video player 122 in other embodiments, has a program store 208 that uses a hard drive or other storage medium, such as an optical disk, flash memory, SRAM, removable disk, and/or magnetic tape. Included in the set top box 120 are a controller 204, a program store 208, a program receiver 212, a display interface 216, a channel display 220, a control transceiver 224, the preference database 160, the alternate version profile database 162, and the program information database 164. In various embodiments, the set top box 120 could be combined with other equipment such as a television, a computer, a video tuner, a home gateway, a digital music player, a personal video recorder, a portable or mobile video device, etc.

The program receiver 212 tunes to one or more program streams to display and/or record them. With proper authorization, the program receiver 212 can tune to hidden channels to receive club programs, alternative and/or additional content that are not typically viewable before storage. The hidden channel could be an encrypted MPEG channel or an IP data delivery channel. In various embodiments, the hidden channel could use a terrestrial broadcast, cable television, DBS satellite, and/or other transport format.

Presentation of live or recorded programs is done by the display interface 216, which is coupled to a monitor, plasma or LCD panel, projection system, or other video viewing device 234. The remote control receiver 228 receives keystrokes from a remote or other input device. Although some of the embodiments discuss the use of a remote control for activating certain functions, it is to be understood that other embodiments may include alternative methods for activating those functions. For example, voice activation, among other alternatives, may be used for such activation. The channel currently being played is shown on the channel display 220, which could also or alternatively appear superimposed on the display.

The control transceiver 224 receives and sends control information. Information for the program information database 164 is received by the control transceiver 224 and could be customized by the delivery system 100-1 for a particular set top box 120 and/or user account. Information in the preference database 160 along with billing and other information is passed by the control receiver to the network node and/or headend 124 in some embodiments. Programs could be passed through the control channel for storage in the program store 208 in addition to passing through the more typical path of the program receiver 212.

The program store 208 could be a video cassette recorder, a digital tape recorder, a hard drive, solid state storage, an optical drive, or other known storage media. The storage media could be removable or non-removable. The storage device could be external to the set top box 120 and coupled thereto with a dedicated cable, wireless transceiver, and/or packet switched network. In some embodiments, the program store 208 could be, for example, in a residential gateway, in another computer on the network, in a network storage device, or in a storage device peripheral coupled to the set top box 120. In one embodiment, programs are received in a compressed and/or encrypted format and stored on the program store 208. As or while the program is being played the compression and/or encryption is removed.

Recordings are stored in the program store 208. These could include an original cut and alternative or additional content. Typically, the program store 208 has a subset of programs available from the headend store 144. Club memberships, subscriptions, on-demand programs purchased, and time-shifted linear scheduled programs all can affect what could be held in the program store 208. Digital rights management (DRM) may be enforced by the controller 204 to regulate access to stored programs either on the set top box 120 or on a removable or separate store. Some embodiments allow offloading programs from the program store 208 in digital form for playing on other set top boxes 120, computers, DVD players, and/or portable media players.

The program information database 164 holds program information for the programs available from the set top box 120. The stored information is typically a subset of that stored proximate to the headend 124. Tailoring of the program information database 164 could be influenced by preferences and subscribed services. Additionally, the program information database 164 has various time lengths recorded for the various custom cuts that may be possible with the applicable version profiles. The IPG would accurately reflect the length for the specified version profiles as applied to a program.

Subsets of the program information database 164 relevant to the program(s) available to the set top box 120 and the preference database 160 relevant to the user could be placed on the removable media or portable player to allow the guide customizations to flow to that portable device. For example, this embodiment includes a portable player 232 that could be connected to the set top box 120 with a cable, docking station or wireless interface. When coupled together, the preference database 160 and program information database 164 portions relevant to the portable player 232 could be loaded onto smaller versions of these databases within the portable player. The customized cut specified by the version profile could be loaded on the portable player or the player could modify the program itself in other embodiments. Programs may be available on demand to the portable player 232 with a wired or wireless data port or may be available from broadcast via a satellite or terrestrial broadcast. The portable player 232 could be a personal video player, a wireless phone, a satellite radio, a car video system, etc.

The presentation of information from the set top box 120 can be customized for particular set top boxes 120, households and/or users. A preference database 160 stores customization parameters to facilitate the personalization of the set top box interface and programs. The personalization can be per user, household or set top box 120 under the direction of the user. Information such as viewing habits, preferences, menu customizations, favorite shows, programs scheduled for recording, channel nicknames, parental controls, IpG profile, IPG customizations etc., can be stored in the preference database 160 for use by the program delivery system 100. For example, the program delivery system 100 can customize the menus singlecasted to a user based upon information in the preference database 160. The preference information can be passively gathered by tracking users and/or actively gathered by the user answering questions. The preference database 160 also stores information used to screen or filter which programs are made available or presented by the set top box 120 or which version profile(s) to apply by default.

Similar to the remote version, the alternate version profile database 162 stores version profiles likely to be used by the set top box 120. These profiles could be a subset of those available at the headend 124. Some embodiments of the set top box 120 only store one or two profiles and download any additional profiles as needed. Typically, a default profile specifying the original cut is shipped with the set top box 120 and is used unless another version profile(s) is preferred by the user.

Operation of the set top box 120 is managed by the controller 204 with use of supporting software and/or hardware. The program information database 164 and preference database 160 are used by the controller 204 to present menu screens according to the current IPG profile, filter club programs for the users of the set top box 120 and create custom cuts using the version profile(s). Some embodiments of the set top box 120 customize the current IPG profile according to the user(s) interacting with the set top box 120. Biometric recognition, such as face recognition, voice recognition or keystroke recognition, could be used to determine the user. Alternative embodiments could augment or replace the automatic recognition with a screen prompt or a button on the remote. A button or switch on the remote could be assigned such that each user could indicate his or her presence. Once the identity of the viewer is known, the set top box 120 actively or passively updates the preferences for the viewer in a multiple viewer household. Other embodiments could merely have a single set of preferences for all possible viewers and not try to resolve the particular viewer.

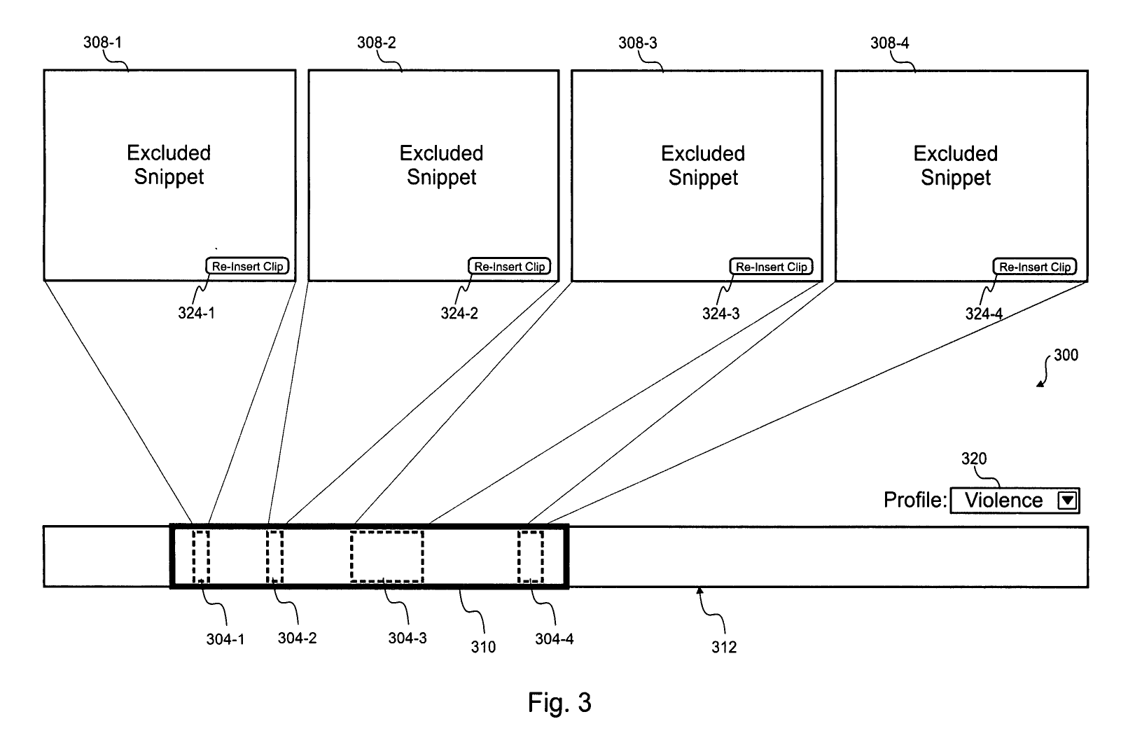

With reference to FIG. 3, a screen shot 300 of an embodiment of a program editing application is shown. This embodiment shows an example of a violence version profile 320 being selected. Other embodiments could allow editing a number of version profiles 320. The program time line 312 shows the whole program, which is navigable in a carousel fashion by moving a displayed portion 310 through the program time line 312. For this example, there are four excluded snippets 308 of video in the displayed portion 310. Each of these excluded snippets 308 can be viewed simultaneously or in any sequential order. A button 324 allows reinsertion of the snippet 308. If this profile had added or alternative snippets those could be modified or changed using the same interface.

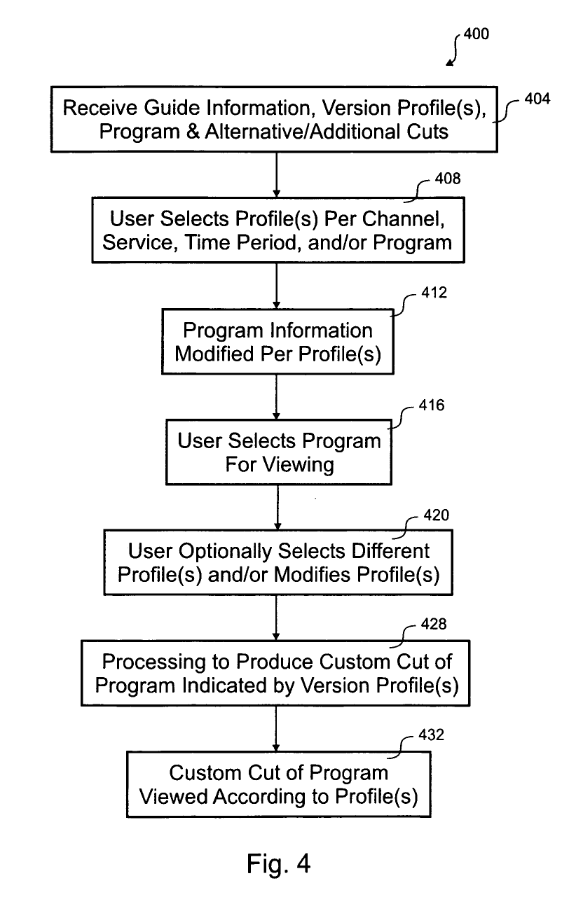

Referring next to FIG. 4, a flow diagram of an embodiment of a process 400 for customizing received programs is shown. The depicted portion of the process 400 begins in step 404 where a guide information, version profiles and a program are received. These items can be received at different times and typically are. The guide information along with the version profiles allow a user to select a program along with the custom cut from the available options. The program may be streamed immediately, downloaded at some later time or be already downloaded as part of a club subscription of some sort. The additional/alternative cuts may be downloaded at any time prior to being needed for playback. Some embodiments send the additional/alternative information at a predetermined time and it may or may not be stored based upon selected profiles. For example, in a satellite topology, downstream broadcast is inexpensive. All set tops or only those that anticipate needing the additional/alternative content would download it.

The user selects one or more version profiles on a per channel, service tier, content provider, time period, user, and/or program in step 408. Where a selected version profile is not available for a particular program, the modifications are not made, but any other indicated modifications that had an available version profile would be made. In step 412, the program information in the program information database 164 is modified according to the relevant version profiles for affected programs. In this way, the IPG indicates the proper time lengths and any icons that would indicate the changes to the original cut that would produce the custom cut indicated in the IPG.

At some point, the user selects a program from the IPG or otherwise in step 416. The program could be a VOD streamed program, a stored VOD program or a program from the linear schedule. The user can determine which version profiles are applied by default to the original cut and can optionally select different version profiles in step 420. The switching, adding or removal of snippets is performed in step 428 according to the active version profiles. The user views the program in step 432. The editing in step 428 and the viewing in step 432 can be done simultaneously so long as the current playback point is available to the user.

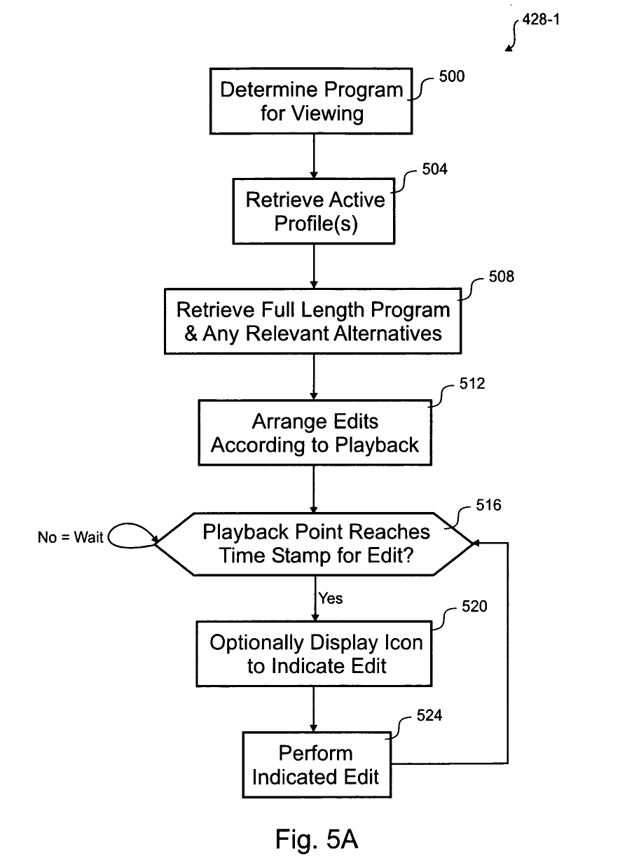

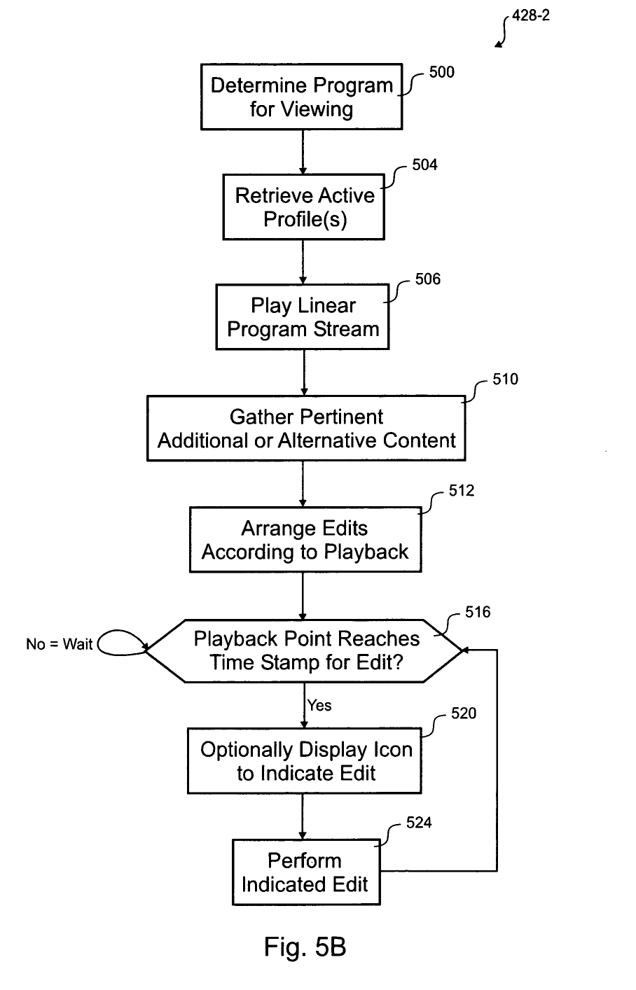

With reference to FIG. 5A, a flow diagram of an embodiment of a process 428-1 for manipulating and displaying a VOD program is shown. The depicted portion of the process begins in step 500 where the program selected for editing is determined 500. The active profiles are retrieved from the alternate version profile database 162 in step 504. The original cut version of the program is retrieved along with relevant additions and alternate snippets in step 508. This information to modify the original into the custom cut may be stored with the set top box, a neighborhood node and/or the headend. In one embodiment, the original cut may be a streamed VOD program that is buffered and modified before viewing. In some embodiments, the common elements for all possible custom cuts is distributed before modification to achieve the particular custom cut indicated in the selected version profiles.

The edits from the various selected version profiles are arranged in step 512. This arrangement may include prioritization of conflicting edits. When the playback point reaches the time stamp for an edit as determined in step 516, an icon signaling the edit is optionally displayed. The indicated edit is performed in step 524. Although this embodiment, performs editing during playback, other embodiments could perform all modifications before playback.

Referring next to FIG. 5B, a flow diagram of an embodiment of a process 428-2 for manipulating and displaying a linearly scheduled program is shown. This embodiment modifies linearly scheduled programs or programs streamed during playback. Step 508 of FIG. 5A is replaced by steps 506 and 510 in this embodiment. From step 504, the linear or streamed program begins playback in step 506. The additional content is gathered in step 510. This additional or alternative content could be sent down the same channel or a different channel. In some embodiments, this additional or alternative content is downloaded from a packet switched network or from a satellite channel. The version profile indicates where this content is retrieved from.

A number of variations and modifications of the disclosed embodiments can also be used. For example, some embodiments could modify spoken content or music that may not have video images associated with it. Alternate content and content removal or insertion can be performed on these types of content.

While the principles of the invention have been described above in connection with specific apparatuses and methods, it is to be clearly understood that this description is made only by way of example and not as limitation on the scope of the invention.

1. A method for distributing a video program that is automatically transformable into an edited video program under control of a user, the method comprising the steps of:
storing a plurality of version profiles, wherein:
each of the plurality of version profiles indicate a plurality of electronic edits for the video program, and
the plurality of electronic edits specify modification of at least one of a video portion or an audio portion of the video program;
transmitting the video program away from a first location to at least a second location geographically separate from the first location; and
transmitting at least a subset of the plurality of version profiles away from the first location to at least the second location geographically separate from the first location.

2. The method for distributing the video program that is automatically transformable into the edited video program under the control of the user as recited in claim 1, further comprising a step of receiving user preferences that specify the subset of the plurality of version profiles to apply to the video program, wherein the user preferences are associated with the user.

3. The method for distributing the video program that is automatically transformable into the edited video program under the control of the user as recited in claim 1, wherein the user is located at the second location.

4. The method for distributing the video program that is automatically transformable into the edited video program under the control of the user as recited in claim 1, further comprising steps of:
processing the video program at the second location with the subset to produce the edited video program; and
playing the edited video program for the user.

5. The method for distributing the video program that is automatically transformable into the edited video program under the control of the user as recited in claim 1, wherein the step of transmitting the video program comprises a step of transmitting the video program simultaneously to a plurality of locations geographically separate from the first location.

6. The method for distributing the video program that is automatically transformable into the edited video program under the control of the user as recited in claim 1, wherein at least two of the plurality of version profiles can be used either alone or in combination to modify the video program.

7. A computer system adapted to perform the computer-implementable method for distributing the video program that is automatically transformable into the edited video program under the control of the user of claim 1.

8. A method for processing a video program into an edited video program as specified by a user, the method comprising the steps of:
receiving user preferences that specify a version profile to apply to the video program, wherein the user preferences are associated with the user;
receiving the version profile, wherein the version profile indicates a plurality of electronic edits for the video program;
receiving the video program from a first location geographically separate from a second location, wherein the video program is received in digital form;
processing the video program at the second location with the version profile to produce the edited video program; and
playing the edited video program for the user.

9. The method for processing the video program into the edited video program as specified by the user as recited in claim 8, wherein the electronic edits include at least one of switching content, inserting content, or deleting content.

10. The method for processing the video program into the edited video program as specified by the user as recited in claim 8, wherein the video program is sent from the first location.

11. The method for processing the video program into the edited video program as specified by the user as recited in claim 8, wherein the version profile is produced from a chosen subset of a plurality of version profiles.

12. The method for processing the video program into the edited video program as specified by the user as recited in claim 8, wherein the processing the video program step comprises a step of inserting content into the video program to produce the edited video program.

13. The method for processing the video program into the edited video program as specified by the user as recited in claim 8, further comprising a step of downloading content specified by the version profile after the video program receiving step has started.

14. The method for processing the video program into the edited video program as specified by the user as recited in claim 8, wherein the video program is, at least in part, received coextensive in time with a plurality of receivers.

15. The method for processing the video program into the edited video program as specified by the user as recited in claim 8, further comprising a step of multicasting the version profile away from the first location to at least a second location geographically separate from the first location.

16. A computer system adapted to perform the computer-implementable method for processing the video program into the edited video program as specified by the user of claim 8.

17. A content receiver for processing a video program into an edited video program as specified by a user, the content receiver comprising:
a version profile, wherein the version profile indicates a plurality of electronic edits for applying to the video program;
user preferences that specify the version profile, wherein the user preferences are associated with the user; and
a receiver for receiving at least one of the version profile and the video program, wherein:
the video program is received from a first location geographically separate from the second location,
the video program is received in digital form,
the video program is processed at the second location with the version profile to produce an edited video program, and
the edited video program is played for the user.

18. The content receiver for processing the video program into the edited video program as specified by the user as recited in claim 17, wherein at least two of the plurality of version profiles can be used either alone or in combination to modify the video program.

19. The content receiver for processing the video program into the edited video program as specified by the user as recited in claim 17, wherein the user is located at a third location geographically separate from at least one of the first and second locations.

20. The content receiver for processing the video program into the edited video program as specified by the user as recited in claim 17, wherein one of the version profiles changes the video program to a different aspect ratio to produce the edited video program.

21. The content receiver for processing the video program into the edited video program as specified by the user as recited in claim 17, wherein the electronic edits include one or more of:
removing part of a soundtrack;
obscuring part of the soundtrack with a stock sound;
replacing part of the soundtrack with a substitute;
cropping part of a video image frame;
blocking part of the video image frame;
blurring part of the video image frame;
removing part of the video program;
obscuring part of the video program; and
replacing part of the video program.
